(19) United States
(12) Patent Application Publication
(10) Pub. No.: US 2025/0344165 A1
(43) Pub. Date: Nov. 6, 2025

(54) DETERMINING CHANNELS AND SIGNALS FOR APPLYING A TIME ADVANCE

(71) Applicant: Telefonaktiebolaget LM Ericsson (publ), Stockholm (SE)

(72) Inventors: Shiwei Gao, Ottawa (CA); Claes Tidestav, Stockholm (SE); Siva Muruganathan, Ottawa (CA)

(21) Appl. No.: 18/860,734

(22) PCT Filed: May 1, 2023
(86) PCT No.: PCT/IB2023/054526

§ 371 Date: Oct. 28, 2024

Related U.S. Application Data
(60) Provisional application No. 63/336,379, filed on Apr. 29, 2022.

(51) Int. Cl. H04W 56/00; H04W 72/21

(52) U.S. Cl. CPC H04W 56/001; H04W 72/21

(57) ABSTRACT

Systems and methods for determining channels and signals for applying a time advance are provided. In some embodiments, a method performed by a User Equipment (UE) for associating Uplink (UL) channels and/or signals to a Timing Advance Group (TAG) includes: grouping UL channels and/or signals into at least two groups, each associated with a TAG; associating a TAG index with an UL channel and/or signal by one or more of: configuring an identifier representing the TAG (e.g., including a TAG ID) in a UL Transmission Configuration Indication (TCI) state; and configuring an identifier representing the TAG (e.g., including a TAG ID) in a joint TCI state; and utilizing, for UL transmission, the TAG ID associated with the UL channel and/or signal. In this way, different TAs are able to be applied to different UL channels/signals by grouping the UL channels/signals.

### RELATED APPLICATIONS

This application claims the benefit of provisional patent application Ser. No. 63/336,379, filed Apr. 29, 2022, the disclosure of which is hereby incorporated herein by reference in its entirety.

### TECHNICAL FIELD

The present disclosure relates to associating channels and signals to a Timing Advance Group (TAG) in a cell.

### BACKGROUND

NR uses CP-OFDM (Cyclic Prefix Orthogonal Frequency Division Multiplexing) in both downlink (DL) (i.e., from a network node, gNB, or base station, to a user equipment or UE) and uplink (UL) (i.e., from UE to gNB). DFT spread OFDM is also supported in the uplink. In the time domain, NR downlink and uplink are organized into equally sized subframes of 1 ms each. A subframe is further divided into multiple slots of equal duration. The slot length depends on subcarrier spacing. For subcarrier spacing of Δf=15 kHz, there is only one slot per subframe, and each slot consists of 14 OFDM symbols.

Data scheduling in NR is typically in slot basis, an example is shown in FIG. 1 with a 14-symbol slot, where the first two symbols contain Physical Downlink Control Channel (PDCCH) and the rest contains physical shared data channel, either Physical Downlink Shared Channel (PDSCH) or Physical Uplink Shared Channel (PUSCH).

Different subcarrier spacing values are supported in NR. The supported subcarrier spacing values (also referred to as different numerologies) are given by Δf=(15× 24) kHz where μ∈{0, 1, 2, 3, 4}. Δf=15 kHz is the basic subcarrier spacing. The slot durations at different subcarrier spacings is given by 1/2^{μ} ms.

In the frequency domain, a system bandwidth is divided into Resource Blocks (RBs), each corresponds to 12 contiguous subcarriers. The RBs are numbered starting with 0 from one end of the system bandwidth. The basic NR physical time-frequency resource grid is illustrated in FIG. 2, where only one RB within a 14-symbol slot is shown. One OFDM subcarrier during one OFDM symbol interval forms one Resource Element (RE).

Downlink transmissions to a UE can be dynamically scheduled by sending Downlink Control Information (DCI) with a DL DCI format on PDCCH. The DCI contains scheduling information such as time and frequency resource, modulation and coding scheme, etc. The user data are carried on PDSCH. The UE first detects and decodes PDCCH and if the decoding is successfully, it then decodes the corresponding PDSCH according to the scheduling information in the DCI.

Similarly, uplink data transmission can be dynamically scheduled using a UL DCI format on PDCCH. A UE first decodes uplink grants in the DCI and then transmits data over PUSCH according to the control information contained in the uplink grant such as modulation order, coding rate, uplink resource allocation, etc.

In addition to dynamic scheduling, semi-persistent transmission of PUSCH using configured grants (CG) is also supported in NR. There are two types of CG based PUSCH defined in NR Rel-15. In CG type 1, a periodicity of PUSCH transmission as well as the time domain offset are configured by RRC. In CG type 2, a periodicity of PUSCH transmission is configured by RRC and then the activation and release of such transmission is controlled by DCI, i.e., with a PDCCH.

### DL Antenna Quasi Co-Location

Several signals can be transmitted from different antenna ports of a same base station. These signals can have the same large-scale properties such as Doppler shift/spread, average delay spread, or average delay. These antenna ports are then said to be quasi co-located (QCL).

If the UE knows that two antenna ports are QCL with respect to a certain parameter (e.g., Doppler spread), the UE can estimate that parameter based on one of the antenna ports and apply that estimate for receiving signal on the other antenna port.

An antenna port is defined by a reference signal (RS) in NR, hence QCL relations between antenna ports are described by QCL relations between a source RS and a target RS. In NR, four types of QCL relations between a source RS and a target RS were defined as follows:
Type A: {Doppler shift, Doppler spread, average delay, delay spread}
Type B: {Doppler shift, Doppler spread}
Type C: {average delay, Doppler shift}
Type D: {Spatial Rx parameter}

Information about what assumptions can be made regarding QCL is signaled to the UE from the network via Transmit Configuration Indicator, TCI, states.

Each TCI state contains QCL information, i.e., one or two source DL RSs and the associated QCL type. The source DL RS can be a Channel State Information reference signal, CSI-RS, or a Synchronization Signal and PBCH, SS/PBCH, block. If two source RSs are configured, one of them is associated with QCL type D. For example, a TCI state may contain {CSI-RS1, QCL Type A} and {CSI-RS2, QCL Type D}, which means the UE can derive Doppler shift, Doppler spread, average delay, delay spread from CSI-RS1 and Spatial Rx parameter (i.e., the RX beam to use) from CSI-RS2.

In NR Rel-15 and Rel-16, a list of TCI states can be RRC configured for PDSCH and up to 8 TCI states from the list may be activated by a Medium Access Control (MAC) Control Element (CE). The up to 8 activated TCI states are mapped to up to 8 TCI codepoints, where each TCI codepoint can contain one of the activated TCI states for PDSCH transmission from a single Transmission and Reception Point (TRP) and two of the activated TCI states for PDSCH transmission from two TRPs. For dynamically scheduled PDSCH, the associated TCI state(s) is indicated in a TCI codepoint of the corresponding DCI scheduling the PDSCH.

For PDCCH, each CORSET is RRC configured with a list of TCI states and one of the list of TCI states is activated by a MAC CE. TCI state for a PDCCH is determined by the TCI state activated for a Control Resource Set (CORESET) in which the PDCCH is transmitted.

For periodic CSI-RS, the corresponding TCI state is RRC configured in each CSI-RS resource. For semi-persistent CSI-RS, the associated TCI state is indicated in the corresponding activation MAC CE. For aperiodic CSI-RS, the TCI state is RRC configured in the corresponding aperiodic CSI trigger state.

### Spatial Relations for UL Channels/Signals

Spatial relation is used in NR to refer to a spatial relationship between an UL channel or signal and another previously transmitted UL RS or previously received DL RS. The UL channel or signal can be a Physical Uplink control Channel (PUCCH), a PUSCH, or a Sounding Reference Signal (SRS), and the DL RS can be a CSI-RS or SSB (synchronization signal and PBCH block). The UL RS is a periodic SRS (sounding reference signal). The DL RS and UL RS can be in the same serving cell as the UL channel or signal or in a different serving cell than the UL channel or signal.

If an UL signal or channel is spatially related to a DL RS, it means that the UE should transmit the UL signal or channel using a same spatial filter as that used previously for receiving the DL RS. The spatial filter can be an antenna beam. The DL RS is also referred to as the spatial filter reference signal. If an UL signal or channel is spatially related to a UL RS, then the UE should apply the same spatial filter used previously for transmitting the UL RS for transmitting the UL signal or channel.

In NR Rel-15 and Rel-16, spatial relation is configured separately for PUCCH, PUSCH, and SRS. For PUCCH, each PUCCH resource can be RRC configured with up to 8 spatial relations and one of them can be activated by a MAC CE. Each PUCCH spatial relation information contains also a pathloss RS for PUCCH power control purpose.

For SRS, each SRS resource can be RRC configured with an SRS spatial relation. The SRS spatial relation may be updated by MAC CE.

For PUSCH, the spatial relation is the same as that of the associated SRS resource.

Rel-17 Unified TCI State Framework for a single TRP

In 3GPP Rel-17 a new unified TCI state framework was introduced, which aims to streamline the indication of transmit/receive spatial filter (and other QCL properties) to the UE by letting a single TCI state (identified by TCI-StateID_r17) indicate QCL properties for multiple different DL and/or UL signals/channels.

The new unified TCI state framework can include three stages of TCI state indication for all or a subset of DL and UL channels/signals. In the first stage, RRC is used to configure a list of TCI states. In the second stage, one or more of the RRC configured TCI states are activated via MAC-CE signaling and mapped to different TCI codepoints of a TCI field in DCI. Finally, in the third stage, DCI signaling is used to select one of the activated TCI states (or two TCI states in case separate TCI states are used for DL channels/signals and UL channels/signals).

Both Joint DL/UL TCI and separate DL/UL TCI are supported in NR Rel-17. For Joint DL/UL TCI, a single TCI state is used to determine a transmit/receive spatial filter for both DL signals/channels and UL signals/channels. For Separate DL/UL TCI, one DL TCI state is used to indicate a receive spatial filter for DL signals/channels and a separate UL TCI state is used to indicate a transmit spatial filter for UL signals/channels.

For PDCCH and dynamically scheduled PDSCH, if a UE is provided TCI-StateID_r17, a DM-RS antenna port for PDCCH receptions in a CORESET, other than a CORESET with index 0, associated only with UE specific search space (USS) sets and/or Type3-PDCCH common search space (CSS) sets, and a DM-RS antenna port for PDSCH receptions scheduled by DCI formats provided by PDCCH receptions in the CORESET are quasi co-located with reference signals provided by the indicated TCI-State-r17.

If a UE is provided with a higher layer parameter useIndicatedTCIState for a CORESET, other than a CORESET with index 0, associated only with CSS sets other than Type3-PDCCH CCS sets, and if useIndicatedTCIState is set as enabled, a DM-RS antenna port for PDCCH receptions in the CORESET and a DM-RS antenna port for PDSCH receptions scheduled by DCI formats provided by PDCCH receptions in the CORESET are quasi co-located with reference signals provided by the indicated TCI-state-r17.

When the UE is configured with TCI-State(s) with tci-StateId_r17 for UL, the UE shall perform PUCCH transmission and PUSCH transmission corresponding to a Type 1 configured grant or a Type 2 configured grant or a dynamic grant according to the RS configured with qcl-Type set to ‘typeD’ of the indicated TCI-State with tci-StateId_r17.

If an SRS resource [set] is configured with useIndicatedTCIState, the UE shall transmit the target SRS resource(s) within the SRS resource set according to the RS configured with qcl-Type set to ‘typeD’ in SourceRs-Info-r17 of the indicated TCI-State with tci-Stateld_r17.

The RS can be a CSI-RS resource in a NZP-CSI-RS-ResourceSet configured with higher layer parameter repetition, a CSI-RS resource in an NZP-CSI-RS-ResourceSet configured with higher layer parameter trs-Info or, in case TCI-State with tci-StateId_r17 is for UL only, an SRS resource with the higher layer parameter usage set to ‘beamManagement’, or SS/PBCH block associated with the same or different PCI from the PCI of the serving cell.

### Multi-DCI Scheduling in Rel-16

In NR Release 16, multi-DCI based DL and UL scheduling was introduced, in which a UE may receive two DCI formats, a first and a second DCI formats, carried by two PDCCHs, a first and a second PDCCHs, in two CORESETs, a first and a second CORESETs, respectively, in a slot. The first and second CORESETs are associated with a first and a second CORESET pool indices. The first and second DCI formats schedule a first and a second PDSCHs transmitted from a first and a second transmission and reception points, TRPs, respectively. It is assumed that the time difference between the two TRPs are very small and within the Cyclic Prefix (CP) so that a common DL and UL timing is used for both TRPs.

FIG. 3 illustrates an example of multi-DCI based PDSCH scheduling from two TRPs. An example is shown in FIG. 3, where PDCCH 1 is received in CORESET 1 with CORESET pool index=0 scheduling PDSCH1 from TRP1 while PDCCH 2 is received in CORESET 2 with CORESET pool index=1 scheduling PDSCH2 from TRP2. The two PDSCHs may be fully, partially, or non-overlapping in time. The HARQ-ACK associated with PDSCH1 and PDSCH2 are carried in PUCCH1 and PUCCH2, respectively, which are non-overlapping in time and are transmitted towards TRP1 and TRP2, respectively.

Similarly, a PUSCH towards TRP1 can be scheduled by a DCI format carried in a PDCCH in CORESET 1, and a PUSCH towards TRP2 can be scheduled by a DCI format carried in a PDCCH in CORESET 2. FIG. 4 illustrates an example of multi-DCI based PUSCH scheduling from two TRPs. An example is shown in FIG. 4, where PDCCH 3 in CORESET 1 with CORESET pool index=0 scheduling PUSCH1 from TRP1 while PDCCH 4 in CORESET 2 with CORESET pool index=1 scheduling PUSCH2 from TRP2. PUSCH1 and PUSH2 are non-overlapping in time.

For multi-DCI multi-TRP operation, a UE needs to be configured with two CORESET pools, each associated with a TRP. Each CORESET pool is a collection of CORESETs configured with a same CORESET pool index.

### Time Alignment and Uplink Synchronization in NR

Different UEs in a same serving cell may be located at different locations within the cell and thus, have different distances to the base station (e.g., NR gNB). A UE in NR typically acquires DL slot and symbol timing based on a SSB during cell search and transmits in the UL a PRACH preamble associated with the SSB towards the base station using the DL timing as a reference. Due to round trip propagation delay, the PRACH may be received at the base station with a time offset with respect to the expected UL timing at the base station. A timing correction is then sent from the base station to the UE in a RACH response message (RAR) for the UE. The timing correction is referred to as a Timing Advance (TA), which is used to compensate the round-trip propagation delay such that the subsequent UL channels or signals can reach the base station at the desired UL slot or symbol time.

FIG. 5 illustrates time alignment of uplink transmissions with timing advance. An example is shown in FIG. 5, where to achieve UL time alignment at the base station a time advance of N_{TA}=2t is needed for UL transmissions at the UE with respect to the DL timing at the UE to compensate the UL time offset due to the propagation delay τ.

Note that the UL symbol or slot timing at a base station may be shifted with respect to the DL timing by a configurable time offset. In that case, the UE may be configured with a fixed time advance offset N_{TA,offset} and N_{TA} is applied in addition to the fixed time advance offset N_{TA,offset}, i.e., the total applied time advance is N_{TA,offset}+N_{TA}.

When the UE has a connection to several different serving cells, the same TA value can sometimes be used for more than one of those cells, e.g., due to that they are co-located and thus always would have the same distance to a UE. Such cells can then be configured as belonging to the same Timing Advance Group (TAG). The configuration of TAGs is done per cell group, i.e., serving cells may be configured as belonging to the same TAG only if they belong to the same cell group (Master cell group (MCG) or Secondary cell group (SCG)).

When the UE does not perform any UL transmissions for some time in a serving cell, the TA value that the UE used earlier may no longer be accurate, e.g., due to the UE has moved and thus has a different propagation delay. In that case, if the UE performs an UL transmission using the latest received TA value it may reach the base station outside the receive window and thus not be correctly received by the base station. The transmission may then even be interfering with other UL transmissions (from other UEs). A timer timeAlignmentTimer is therefore configured for each TAG, to indicate how long the UE can consider itself to be uplink time aligned to serving cells belonging to the associated TAG, without receiving any updates to the TA value. The timeAlignmentTimer thus indicates a time duration within which the UE may consider a received TA value as valid. If the UE does not receive an updated value before timeAlignmentTimer expires, the UE is no longer UL synchronized to the serving cells belonging to the corresponding TAG. The details are described in section 9.2.9 of TS 38.300.

Except initial TA, which is carried in a RACH response message, regular TAs during time maintenance are carried in a time advance command MAC CE as shown in FIG. 6 (reproduced from FIG. 6.1.3.4-1 of 3GPP TS 38.321), where it consists of
TAG Identity (TAG ID): This field indicates the TAG Identity of the addressed TAG. The TAG containing the SpCell (i.e., a special cell which can be a primary cell in MCG or SCG, where a primary cell supports PUCCH transmission and contention-based Random Access, and is always activated) has the TAG Identity 0. The length of the field is 2 bits;
Timing Advance Command: This field indicates the index value T_{A} (0, 1, 2 . . . 63) used to control the amount of timing adjustment that MAC entity has to apply (as specified in TS 38.213). The length of the field is 6 bits.

According to 3GPP TS 38.213, upon reception of a timing advance command for a TAG, the UE adjusts uplink timing for PUSCH/SRS/PUCCH transmission on all the serving cells in the TAG based on a value N_{TA,offset} that the UE expects to be same for all the serving cells in the TAG and based on the received timing advance command where the uplink timing for PUSCH/SRS/PUCCH transmissions is the same for all the serving cells in the TAG.

For a SCS of 2^{μ}·15 kHz, the timing advance command, T_{A}, for a TAG indicates the change of the uplink timing relative to the current uplink timing for the TAG in multiples of 16·64·T_{c}/2^{μ}, where T_{c}=1/(Δfₘₐₓ·N_{f}), Δfₘₐₓ=480·10³ Hz, and N_{f}=4096.

A timing advance command in case of random access response for a TAG indicates N_{TA} values by index values of T_{A}=0, 1, 2, . . . , 3846, where an amount of the time alignment for the TAG with SCS of 2μ·15 KHz is N_{TA}=T_{A}·16·64/2^{μ} and is relative to the SCS of the first uplink transmission from the UE after the reception of the random access.

In other cases, a timing advance command, T_{A}, for a TAG indicates adjustment of a current N_{TA} value, N_{TA_old}, to the new N_{TA} value, N_{TA_new}, by index values of T_{A}=0, 1, 2, . . . , 63, where for a SCS of 2^{μ}·15 kHz, N_{TA_new}=N_{TA_old}+(T_{A}−31)·16·64/2^{μ}.

Each serving cell configuration can have a TAG identifier associated, e.g., SpCell and/or an SCell of the cell group. Two serving cells having configured the same TAG identifier will be assumed by the UE to have the same time alignment timer and belong to the same Time Alignment Group.

### Uplink Time Alignment Maintenance

After the UE is configured with its serving cell(s) for a given cell group (e.g., Master Cell Group (MCG) and/or Secondary Cell Group (SCG)), the UE obtains the initial TA value via random access response (RAR), and is configured with the association between serving cells and TAG identifiers, the UE needs to maintain the time alignment according to the TA procedure defined in Clause 5.2 in TS 38.321.

For time alignment maintenance purpose, a time alignment timer per TAG is used to control how long the MAC entity considers the Serving Cells belonging to the associated TAG to be uplink time aligned.

Upon reception of the Timing Advance Command (which is a MAC CE), the UE applies the time advance indicated in the command if the time alignment timer has not been expired and start/re-start the timer.

When the time alignment timer expires, the following procedure is specified in TS38.321 where a Primary TAG (PTAG) is a TAG containing the SpCell of a MAC entity and a Secondary TAG (STAG) is a TAG containing cells other than a primary cell.
if the time Alignment Timer is associated with the PTAG:
   flush all HARQ buffers for all Serving Cells;
   notify RRC to release PUCCH for all Serving Cells, if configured;
   notify RRC to release SRS for all Serving Cells, if configured;
   clear any configured downlink assignments and configured uplink grants;
   clear any PUSCH resource for semi-persistent CSI reporting;
   consider all running time Alignment Timers as expired;
   maintain N_{TA} of all TAGS.
else if the time Alignment Timer is associated with an STAG, then for all Serving Cells belonging to this TAG:
   flush all HARQ buffers;
   notify RRC to release PUCCH, if configured;
   notify RRC to release SRS, if configured;
   clear any configured downlink assignments and configured uplink grants;
   clear any PUSCH resource for semi-persistent CSI reporting;
   maintain N_{TA} of this TAG.

The MAC entity shall not perform any uplink transmission on a Serving Cell except the Random Access Preamble and MSGA transmission when the timeAlignmentTimer associated with the TAG to which this Serving Cell belongs is not running. Furthermore, when the timeAlignmentTimer associated with the PTAG is not running, the MAC entity shall not perform any uplink transmission on any Serving Cell except the Random Access Preamble and MSGA transmission on the SpCell. Further details of the maintenance procedure can be found in TS38.321.

There currently exist certain challenges. Improved systems and methods for determining channels and signals for applying a time advance are needed.

### SUMMARY

Systems and methods for determining channels and signals for applying a time advance are provided. In some embodiments, a method performed by a User Equipment (UE) for associating Uplink (UL) channels and/or signals to a Timing Advance Group (TAG) includes: grouping UL channels and/or signals into at least two groups, each associated with a TAG; associating a TAG index with an UL channel and/or signal by one or more of: configuring an identifier representing the TAG (e.g., including a TAG ID) in a UL Transmission Configuration Indication (TCI) state; and configuring an identifier representing the TAG (e.g., including a TAG ID) in a joint TCI state; and utilizing, for UL transmission, the TAG ID associated with the UL channel and/or signal. In this way, different TAs are able to be applied to different UL channels/signals by grouping the UL channels/signals.

In some embodiments, associating a TAG index comprises one or more of the group consisting of: each channel/signal configured with a spatial relation uses the associated TAG; each channel/signal configured with a pathloss RS uses the associated TAG; each UL signal associated with an SSB or a Non-Zero Power, NZP, CSI-RS resource uses the associated TAG; and each UL channel/signal configured with an UL TCI state uses the associated TAG.

In some embodiments, a TAG ID is explicitly configured in the corresponding spatial relation information element. In some embodiments, a first TAG is provided by the ‘tag-Id’ configured in the ServingCellConfig of the serving cell. In some embodiments, a second TAG is configured in SRS-SpatialRelationInfo and/or PUCCH-SpatialRelationInfo if the associated SRS/PUSCH or PUCCH are to be transmitted to a TRP associated with a second TAG.

In some embodiments, when ‘tag-Id’ is not configured in SRS-SpatialRelationInfo of an SRS spatial relation, then the first ‘tag-Id’ configured in the ServingCellConfig applies to that SRS spatial relation. In some embodiments, when ‘tag-Id’ is not configured in PUCCH-SpatialRelationInfo of an PUCCH spatial relation, then the first ‘tag-Id’ configured in the ServingCellConfig applies to that PUCCH spatial relation.

In some embodiments, the association with TAG is explicitly configured in the corresponding pathloss RS for each UL channel or signal. In some embodiments, the association with TAG is explicitly configured for each SSB and CSI-RS used for pathloss reference RS. In some embodiments, for SSB to TAG association, a set of SSB indices may be added to each TAG.

In some embodiments, each joint DL/UL or UL TCI state may include a TAG-Id. In some embodiments, the ‘tag-Id’ is optionally configured in DLorJoint-TCIState and/or UL-TCIState. In some embodiments, the first TAG is provided by the ‘tag-Id’ configured in the ServingCellConfig of the serving cell in which SRS, PUCCH, or PUSCH is transmitted. In some embodiments, the wireless device is a New Radio (NR) UE.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates an example of data scheduling in New Radio (NR) with a 14-symbol slot, where the first two symbols contain Physical Downlink Control Channel (PDCCH) and the rest contains physical shared data channel, either Physical Downlink Shared Channel (PDSCH) or Physical Uplink Shared Channel (PUSCH);

FIG. 2 illustrates the basic NR physical time-frequency resource grid where only one RB within a 14-symbol slot is shown;

FIG. 3 illustrates an example of multi-Downlink Control Information (DCI) based PDSCH scheduling from two Transmission and Reception Points (TRPs);

FIG. 4 illustrates an example of multi-DCI based PUSCH scheduling from two TRPs;

FIG. 5 illustrates time alignment of uplink transmissions with timing advance;

FIG. 6 illustrates regular Timing Advances (TAs) during time maintenance are carried in a time advance command Medium Access Control (MAC) Control Element (CE);

FIG. 7 shows an example of Uplink (UL) time alignment to two TRPs with two timing advances, N_{TA1} and N_{TA2} in accordance with some embodiments;

FIG. 8 is an example of flow diagram according to the above embodiments;

FIG. 9 shows an example of a communication system in accordance with some embodiments;

FIG. 10 shows a User Equipment (UE) in accordance with some embodiments;

FIG. 11 shows a network node in accordance with some embodiments;

FIG. 12 is a block diagram of a host, which may be an embodiment of the host of FIG. 9, in accordance with various aspects described herein;

FIG. 13 is a block diagram illustrating a virtualization environment in which functions implemented by some embodiments may be virtualized; and

FIG. 14 shows a communication diagram of a host communicating via a network node with a UE over a partially wireless connection in accordance with some embodiments.

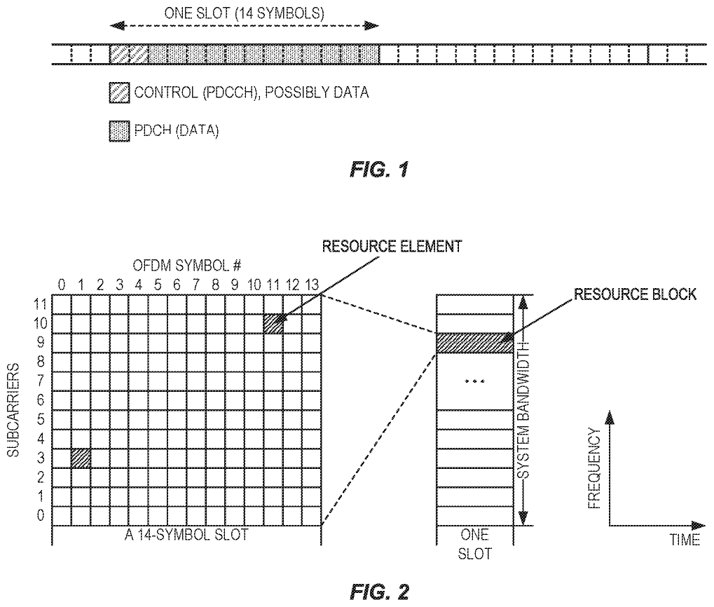

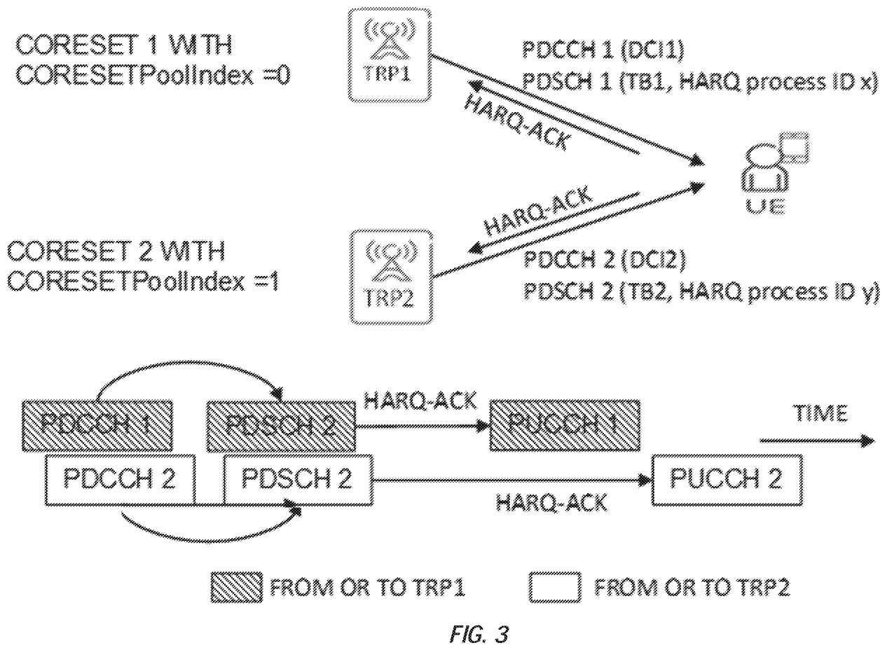

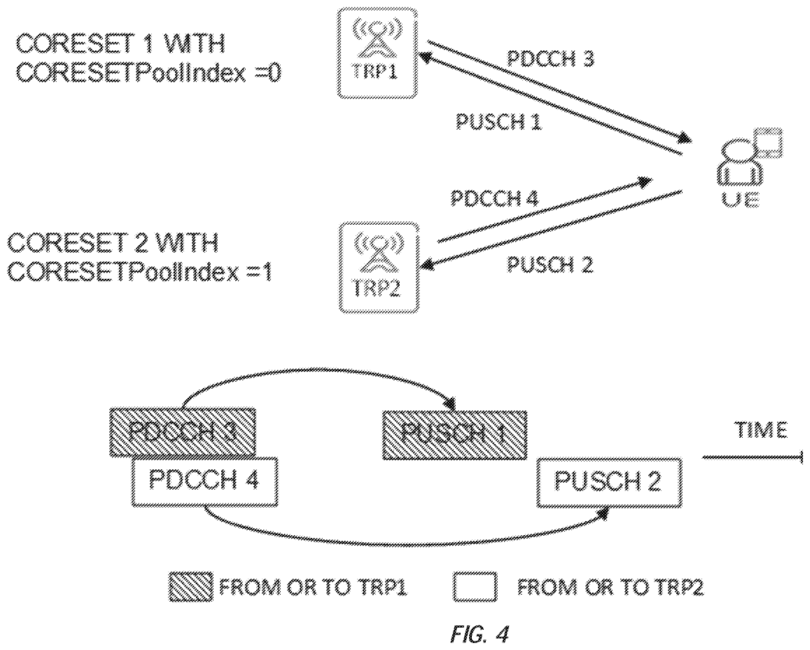

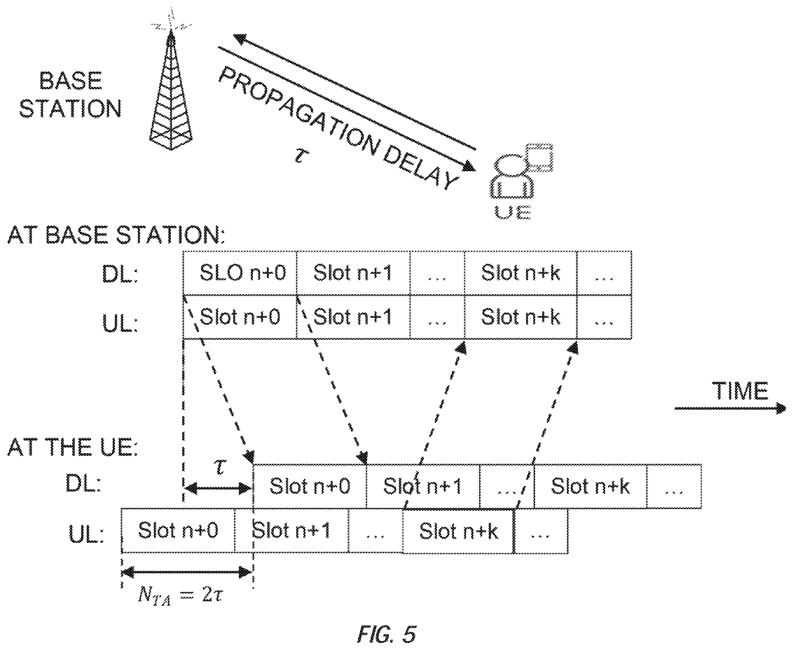

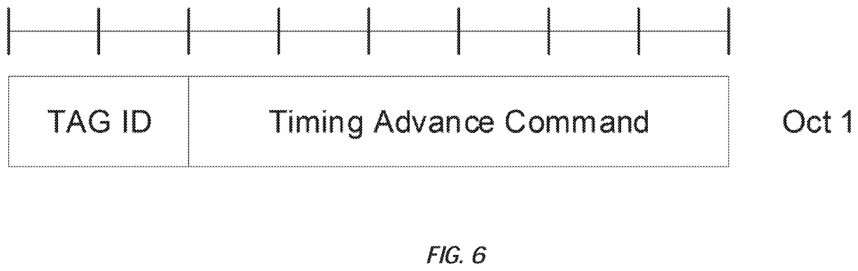

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

In NR Rel-18, two time advances, one for each TRP, are to be studied for multi-DCI based uplink transmissions towards two TRPs where a large time difference between the two TRPs may exist. For UL transmissions to different TRPs, different time advances are applied such that the received UL signals at each intended TRP are time aligned.

In current 3GPP Rel-16 specification for multi-DCI based multi-TRP operation, TRP is not explicitly specified. Instead, CORESETs configured for a UE are divided into two groups, each group is referred to as a CORESET pool. Even though a CORESET pool can be considered as being associated with a TRP, not every UL channel/signal can be linked to a CORESET pool. For example, PUSCH based on type 1 configured grant, SRS, and PUCCH carrying CSI or SR are not associated with any PDCCH and thus, any CORESET. In Rel-16, it is up to the network to ensure that each UL channel/signal to be sent towards a TRP by configuring the correct parameters associated with the TRP such as spatial relation or pathloss reference RS, etc.

Therefore, when two TAs are introduced in Rel-18, how to determine which T_{A} is to be applied to which UL channel/signal is a problem.

Systems and methods for determining channels and signals for applying a time advance are provided. In some embodiments, a method performed by a User Equipment (UE) for associating Uplink (UL) channels and/or signals to a Timing Advance Group (TAG) includes: grouping UL channels and/or signals into at least two groups, each associated with a TAG; associating a TAG index with an UL channel and/or signal by one or more of: configuring an identifier representing the TAG (e.g., including a TAG ID) in a UL Transmission Configuration Indication (TCI) state; and configuring an identifier representing the TAG (e.g., including a TAG ID) in a joint TCI state; and utilizing, for UL transmission, the TAG ID associated with the UL channel and/or signal. In this way, different TAs are able to be applied to different UL channels/signals by grouping the UL channels/signals.

Certain aspects of the disclosure and their embodiments may provide solutions to these or other challenges. A method is proposed for associating UL channels and signals to one of two time advance groups (TAGs) in a cell. In some embodiments, the method comprises one of: including a TAG ID in each spatial relation information element; including a TAG ID in each pathloss reference signal configuration; including a TAG ID in each unified TCI state; associating a TAG ID to a set of SSBs and CSI-RS.

In some embodiments, a method includes: Group UL channels/signals into two groups, each associated a TAG; Associate a TAG index (i.e., TAG1) with: a spatial relation: each channel/signal that is configured with a certain spatial relation uses the associated TAG; a pathloss RS: each channel/signal that is configured with a certain pathloss RS uses the associated TAG; an SSB or NZP CSI-RS resource: each UL signal that is associated with an SSB or an NZP CSI-RS resource uses the associated TAG; an UL TCI: each UL channel/signal that is configured with an UL TCI state uses the associated TAG.

Certain embodiments may provide one or more of the following technical advantage(s). The method enables different TAs to be applied to different UL channels/signals by grouping the UL channels/signals.

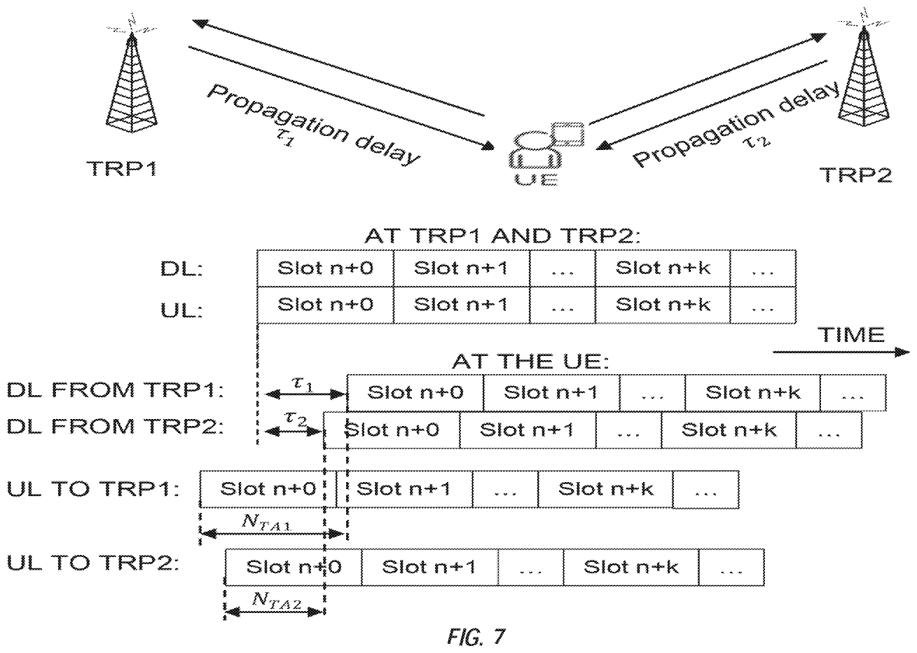

FIG. 7 shows an example of UL time alignment to two TRPs with two timing advances, N_{TA1} and N_{TA2}. In the figure, it is assumed that the DL and UL slot/symbol timings are aligned at the two TRPs. Due to different propagation delays to the UE from the two TRPs, the received DL slot/symbol timings from the two TRPs at the UE are shifted in time. To achieve UL time alignment at each TRP, the UE needs to apply two different timing advances to its UL transmissions towards the two TRPs.

In FIG. 7, each of the two timing advances is with respect to the received DL timing from the respective TRP. Alternatively, both of the two time advances may be with respect to a common DL timing at the UE, e.g., either based on a received DL slot/symbol timing from TRP1 or TRP2.

### Associating UL Channel and Signals to a TAG

It is envisioned that for UL transmission to two TRPs in a serving cell, two TAGs may be configured. For UL channels or signals transmitted towards each TRP, a TAG can be indicated. Different TAG values may be indicated for UL channels and signals to be transmitted to different TRPs. There can be different ways for the TAG indication.

### Associating a TAG to Spatial Relation Information

In one embodiment, a TAG ID is explicitly configured in the corresponding spatial relation information element. For example, it may be configured as part of a PUCCH or SRS spatial relation information element as follows, where a “tag-id” is included in the spatial relation configurations to indicate the associated TAG and corresponding TA.

| | |
|---|---|
| SRS-SpatialRelationInfo ::= | SEQUENCE { |
| servingCellId | ServCellIndex |

OPTIONAL, -- Need S

| | |
|---|---|
| tag-Id | TAG-Id, |
| referenceSignal | CHOICE { |
| ssb-Index | SSB-Index, |
| csi-RS-Index | NZP-CSI-RS- |

ResourceId,

| | |
|---|---|
| srs | SEQUENCE { |
| resourceId | SRS-ResourceId, |
| uplinkBWP | BWP-Id |

```
      }
    }
}
```

| | |
|---|---|
| PUCCH-SpatialRelationInfo ::= | SEQUENCE { |
| pucch-SpatialRelationInfoId | PUCCH- |

SpatialRelationInfoId,

| | |
|---|---|
| servingCellId | ServCellIndex |

OPTIONAL, -- Need S

| | |
|---|---|
| tag-Id | TAG-Id, |
| referenceSignal | CHOICE { |
| ssb-Index | SSB-Index, |
| csi-RS-Index | NZP-CSI-RS- |

ResourceId,

| | |
|---|---|
| srs | PUCCH-SRS |

},

| | |
|---|---|
| pucch-PathlossReferenceRS-Id | PUCCH- |

PathlossReferenceRS-Id,

| | |
|---|---|
| p0-PUCCH-Id | P0-PUCCH-Id, |
| closedLoopIndex | ENUMERATED { i0, i1 } |

}

For PUSCH, UE applies the time advance associated with a TAG configured in the corresponding SRS resource indicated by an SRS resource indicator (SRI) either in DCI scheduling the PUSCH or RRC configured in case of PUSCH with type configured grant.

In one embodiment, the ‘tag-Id’ is optionally configured in SRS-SpatialRelationInfo and/or PUCCH-SpatialRelationInfo. In another embodiment, a first TAG is provided by the ‘tag-Id’ configured in the ServingCellConfig of the serving cell in which SRS, PUCCH, or PUSCH is transmitted. Only the second TAG is configured in SRS-SpatialRelationInfo and/or PUCCH-SpatialRelationInfo if the associated SRS/PUSCH or PUCCH are to be transmitted to a TRP associated with a second TAG.

When ‘tag-Id’ is not configured in SRS-SpatialRelationInfo of an SRS spatial relation, then the first ‘tag-Id’ configured in the ServingCellConfig applies to that SRS spatial relation. Note that the ServingCellConfig here is the information element that contains the serving cell configuration information of the serving cell associated with the SRS-SpatialRelationInfo.

Similarly, when ‘tag-Id’ is not configured in PUCCH-SpatialRelationInfo of an PUCCH spatial relation, then the first ‘tag-Id’ configured in the ServingCellConfig applies to that PUCCH spatial relation. Note that the ServingCellConfig here is the information element that contains the serving cell configuration information of the serving cell associated with the PUCCH-SpatialRelationInfo.

### Associating a TAG to Pathloss RS

In both FR1 and FR2, for power control purpose each UL channel or signal is configured with a DL RS for pathloss measurement, or pathloss reference RS. One or multiple DL RS can be configured and used as pathloss reference RS. Thus, in another embodiment, the association with TAG is explicitly configured in the corresponding pathloss RS for each UL channel or signal. Some examples are shown below for PUCCH, PUSCH and SRS.

| | |
|---|---|
| PUCCH-PathlossReferenceRS ::= | SEQUENCE { |
| pucch-PathlossReferenceRS-Id | PUCCH- |

PathlossReferenceRS-Id,

| | |
|---|---|
| tag-Id | TAG-Id, |
| referenceSignal | CHOICE { |
| ssb-Index | SSB-Index, |
| csi-RS-Index | NZP-CSI-RS- |

ResourceId
}
}

| | |
|---|---|
| PUSCH-PathlossReferenceRS ::= | SEQUENCE { |
| pusch-PathlossReferenceRS-Id | PUSCH- |

PathlossReferenceRS-Id,

| | |
|---|---|
| tag-Id | TAG-Id, |
| referenceSignal | CHOICE { |
| ssb-Index | SSB-Index, |
| csi-RS-Index | NZP-CSI-RS-ResourceId |
| } | |
| } | |
| PathlossReferenceRSList-r16 ::= | SEQUENCE (SIZE |

(1..maxNrofSRS-PathlossReferenceRS-r16)) OF PathlossReferenceRS-
r16

| | |
|---|---|
| PathlossReferenceRS-r16 ::= | SEQUENCE { |
| srs-PathlossReferenceRS-Id-r16 | SRS- |

PathlossReferenceRS-Id-r16,

| | |
|---|---|
| tag-Id | TAG-Id, |

pathlossReferenceRS-r16
PathlossReferenceRS-Config
}

| | |
|---|---|
| PathlossReferenceRS-Config ::= | CHOICE { |
| ssb-Index | SSB-Index, |
| csi-RS-Index | NZP-CSI-RS- |

ResourceId
}

### Associating a TAG to SSB and CSI-RS

The drawback of the above embodiments is that a TAG ID needs to be configured for each UL channel or signal. In a further embodiment, the association with TAG is explicitly configured for each SSB and CSI-RS used for pathloss reference RS. One example is shown below where TAG is configured in each CSI-RS resource.

NZP-CSI-RS-Resource information element

-- ASN1START
-- TAG-NZP-CSI-RS-RESOURCE-START

| | |
|---|---|
| NZP-CSI-RS-Resource ::= | SEQUENCE { |
| nzp-CSI-RS-ResourceId | NZP-CSI-RS-ResourceId, |
| resourceMapping | CSI-RS-ResourceMapping, |
| powerControlOffset | INTEGER (−8..15), |
| powerControlOffsetSS | ENUMERATED{db−3, db0, |
| db3, db6} | OPTIONAL, -- Need R |
| scramblingID | ScramblingId, |
| periodicityAndOffset | CSI- |
| ResourcePeriodicityAndOffset | OPTIONAL, -- Cond |

PeriodicOrSemiPersistent

| | |
|---|---|
| qcl-InfoPeriodicCSI-RS | TCI-StateId |

OPTIONAL, -- Cond Periodic

| | |
|---|---|
| tag-Id | TAG-Id, |

...
}
-- TAG-NZP-CSI-RS-RESOURCE-STOP
-- ASN1STOP

For SSB to TAG association, a set of SSB indices may be added to each TAG. An example is shown below, where one or more SSB indices are included in a TAG configuration.

TAG-Config information element

-- ASN1START
-- TAG-TAG-CONFIG-START

| | |
|---|---|
| TAG-Config ::= | SEQUENCE { |
| tag-ToReleaseList | SEQUENCE (SIZE |
| (1..maxNrofTAGs)) OF TAG-Id | OPTIONAL, |

-- Need N

| | |
|---|---|
| tag-ToAddModList | SEQUENCE (SIZE |
| (1..maxNrofTAGs)) OF TAG | OPTIONAL |

-- Need N
}

| | |
|---|---|
| TAG ::= | SEQUENCE { |
| tag-Id | TAG-Id, |
| timeAlignmentTimer | TimeAlignmentTimer, |
| AssociatedSSBs | SEQUENCE (SIZE (1..maxNrofSSBs)) |

OF SSB-index
...
}

| | |
|---|---|
| TAG-Id ::= | INTEGER (0..maxNrofTAGs-1) |
| TimeAlignmentTimer ::= | ENUMERATED {ms500, ms750, |

ms1280, ms1920, ms2560, ms5120, ms10240, infinity}
-- TAG-TAG-CONFIG-STOP
-- ASN1STOP

### Associating a TAG to Unified TCI States

When unified TCI state framework is used, each UL transmission may be associated with a joint DL/UL TCI state or an UL TCI state. To make it possible to transmit different UL signals with different TAs, each joint DL/UL or UL TCI state may include a TAG-Id:

| | |
|---|---|
| DLorJoint-TCIState-r18 ::= | SEQUENCE { |
| tci-StateUnifiedId-r18 | TCI-StateId, |
| qcl-Type1-r18 | QCL-Info-r18, |
| qcl-Type2-r18 | QCL-Info-r18, OPTIONAL, |

-- Need R

| | |
|---|---|
| ul-powerControl-r18 | Uplink-powerControlId-r18 |

OPTIONAL, -- Need R

| | |
|---|---|
| pathlossReferenceRS-Id-r18 | PUSCH-PathlossReferenceRS- |

Id -r18 OPTIONAL -- Need S

| | |
|---|---|
| tag-Id | TAG-Id, } |
| UL-TCIState-r18 ::= | SEQUENCE { |
| UL-TCIState-Id-r18 | UL-TCIState-Id-r18, |
| servingCellId-r18 | ServCellIndex-r18 |

OPTIONAL, -- Need S

| | |
|---|---|
| tag-Id | TAG-Id, |
| referenceSignal-r18 | CHOICE { |
| ssb-Index-r18 | SSB-Index-r18, |
| csi-RS-Index-r18 | NZP-CSI-RS- |

ResourceId-r18,

| | |
|---|---|
| srs-r18 | PUCCH-SRS-r18 |

},

| | |
|---|---|
| additionalPCI-r18 | AdditionalPCIIndex-r18 |

OPTIONAL, -- Need R

| | |
|---|---|
| ul-powerControl-r18 | Uplink-powerControlId-r18 |

OPTIONAL, -- Need R

| | |
|---|---|
| pathlossReferenceRS-Id-r18 | PUSCH-PathlossReferenceRS-Id- |

r18 OPTIONAL -- Need S
}

In one embodiment, the ‘tag-Id’ is optionally configured in DLorJoint-TCIState and/or UL-TCIState. In another embodiment, the first TAG is provided by the ‘tag-Id’ configured in the ServingCellConfig of the serving cell in which SRS, PUCCH, or PUSCH is transmitted. Only the second TAG is configured in DLorJoint-TCIState and/or UL-TCIState.

When ‘tag-Id’ is not configured in DLorJoint-TCIState of an DL TCI state or Joint TCI state, then the ‘tag-Id’ configured in the ServingCellConfig applies to that DL TCI state or Joint TCI state. Note that the ServingCellConfig here is the information element that contains the serving cell configuration information of the serving cell associated with the DL TCI state or Joint TCI state.

Similarly, when ‘tag-Id’ is not configured in UL-TCIState of an UL TCI state, then the ‘tag-Id’ configured in the ServingCellConfig applies to that UL TCI state. Note that the ServingCellConfig here is the information element that contains the serving cell configuration information of the serving cell associated with the UL TCI state.

Although TAG IDs are used in above to indicated which one of two TAs to be applied for a UL channel or signal, other identifiers may also be used for the same purpose.

In some embodiments, a method performed by a UE for associating an UL channel and/or signal to one of a first TAG and a second TAG in a serving cell includes: receiving a configuration, for the UL channel or signal, of one of: a UL TCI state; a joint DL and UL TCI state; a spatial relation; a pathloss RS; determining one of the first TAG and the second TAG for the UL channel or signal based on a TAG identifier contained in the configuration; and applying, for UL transmission of the UL channel and/or signal, a timing advance, TA, associated to the determined one of the first TAG and the second TAG.

In some embodiments, configuration is via one of a Radio resource control, RRC, signaling, a MAC command, and a physical layer DCI.

In some embodiments, the UL channel or signal is one of a PUSCH, a PUCCH, and a SRS. In some embodiments, the pathloss RS can be one of a CSI-RS and a SSB. In some embodiments, the TAG identifier is used to identify one of the first TAG and the second TAG.

In some embodiments, the first TAG is indicated by a first value of the TAG identifier and the second TAG is indicated by a second value of the TAG identifier. In some embodiments, the first TAG is implicitly indicated if the TAG identifier is not present in the configuration and the second TAG is indicated when the TAG identifier is present in the configuration.

In some embodiments, the TAG identifier is the same as the ‘tag-Id’. In some embodiments, the TAG identifier is different than the ‘tag-Id’. In some embodiments, the first TAG is configured in ServingCellConfig and the second TAG is configured in the spatial relation for SRS, SRS-SpatialRelationInfo, and/or the spatial relation for PUCCH, PUCCH-SpatialRelationInfo.

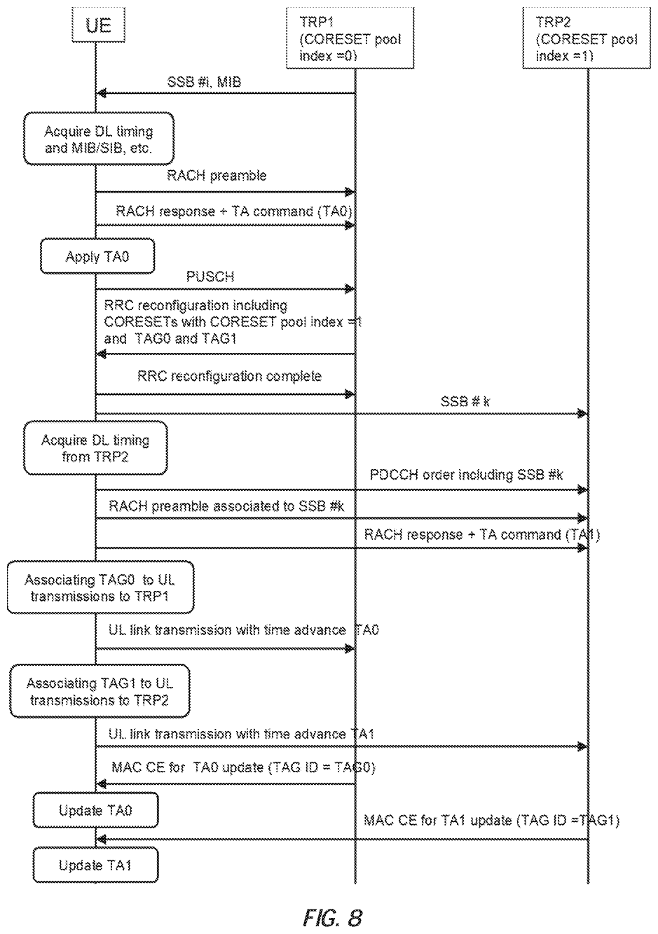

FIG. 8 is an example of flow diagram according to the above embodiments.

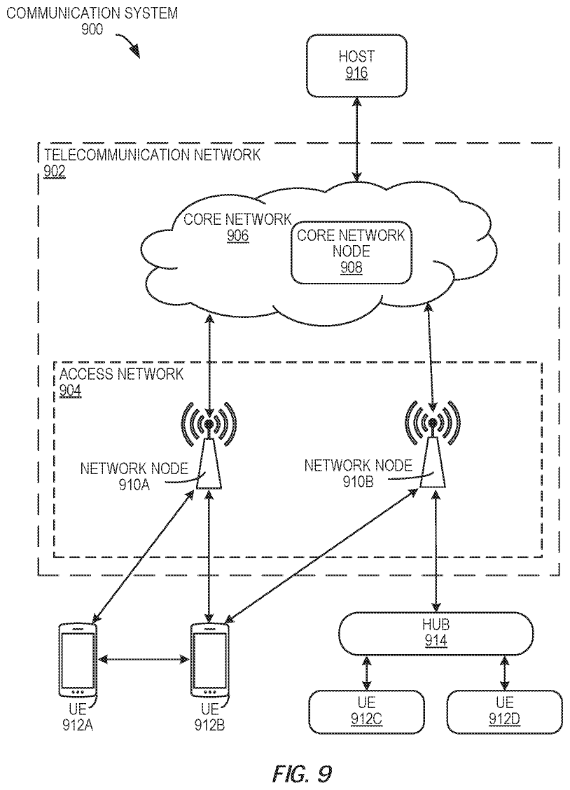

FIG. 9 shows an example of a communication system 900 in accordance with some embodiments.

In the example, the communication system 900 includes a telecommunication network 902 that includes an access network 904, such as a Radio Access Network (RAN), and a core network 906, which includes one or more core network nodes 908. The access network 904 includes one or more access network nodes, such as network nodes 910A and 910B (one or more of which may be generally referred to as network nodes 910), or any other similar Third Generation Partnership Project (3GPP) access node or non-3GPP Access Point (AP). The network nodes 910 facilitate direct or indirect connection of User Equipment (UE), such as by connecting UEs 912A, 912B, 912C, and 912D (one or more of which may be generally referred to as UEs 912) to the core network 906 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 900 may include any number of wired or wireless networks, network nodes, UEs, and/or any other components or systems that may facilitate or participate in the communication of data and/or signals whether via wired or wireless connections. The communication system 900 may include and/or interface with any type of communication, telecommunication, data, cellular, radio network, and/or other similar type of system.

The UEs 912 may be any of a wide variety of communication devices, including wireless devices arranged, configured, and/or operable to communicate wirelessly with the network nodes 910 and other communication devices. Similarly, the network nodes 910 are arranged, capable, configured, and/or operable to communicate directly or indirectly with the UEs 912 and/or with other network nodes or equipment in the telecommunication network 902 to enable and/or provide network access, such as wireless network access, and/or to perform other functions, such as administration in the telecommunication network 902.

In the depicted example, the core network 906 connects the network nodes 910 to one or more hosts, such as host 916. These connections may be direct or indirect via one or more intermediary networks or devices. In other examples, network nodes may be directly coupled to hosts. The core network 906 includes one more core network nodes (e.g., core network node 908) that are structured with hardware and software components. Features of these components may be substantially similar to those described with respect to the UEs, network nodes, and/or hosts, such that the descriptions thereof are generally applicable to the corresponding components of the core network node 908. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 916 may be under the ownership or control of a service provider other than an operator or provider of the access network 904 and/or the telecommunication network 902, and may be operated by the service provider or on behalf of the service provider. The host 916 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 900 of FIG. 9 enables connectivity between the UEs, network nodes, and hosts. In that sense, the communication system 900 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 902 is a cellular network that implements 3GPP standardized features. Accordingly, the telecommunication network 902 may support network slicing to provide different logical networks to different devices that are connected to the telecommunication network 902. For example, the telecommunication network 902 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 912 are configured to transmit and/or receive information without direct human interaction. For instance, a UE may be designed to transmit information to the access network 904 on a predetermined schedule, when triggered by an internal or external event, or in response to requests from the access network 904. Additionally, a UE may be configured for operating in single- or multi-Radio Access Technology (RAT) or multi-standard mode. For example, a UE may operate with any one or combination of WiFi, New Radio (NR), and LTE, i.e. be configured for Multi-Radio Dual Connectivity (MR-DC), such as Evolved UMTS Terrestrial RAN (E-UTRAN) NR-Dual Connectivity (EN-DC).

In the example, a hub 914 communicates with the access network 904 to facilitate indirect communication between one or more UEs (e.g., UE 912C and/or 912D) and network nodes (e.g., network node 910B). In some examples, the hub 914 may be a controller, router, content source and analytics, or any of the other communication devices described herein regarding UEs. For example, the hub 914 may be a broadband router enabling access to the core network 906 for the UEs. As another example, the hub 914 may be a controller that sends commands or instructions to one or more actuators in the UEs. Commands or instructions may be received from the UEs, network nodes 910, or by executable code, script, process, or other instructions in the hub 914. As another example, the hub 914 may be a data collector that acts as temporary storage for UE data and, in some embodiments, may perform analysis or other processing of the data. As another example, the hub 914 may be a content source. For example, for a UE that is a Virtual Reality (VR) headset, display, loudspeaker or other media delivery device, the hub 914 may retrieve VR assets, video, audio, or other media or data related to sensory information via a network node, which the hub 914 then provides to the UE either directly, after performing local processing, and/or after adding additional local content. In still another example, the hub 914 acts as a proxy server or orchestrator for the UEs, in particular in if one or more of the UEs are low energy IoT devices.

The hub 914 may have a constant/persistent or intermittent connection to the network node 910B. The hub 914 may also allow for a different communication scheme and/or schedule between the hub 914 and UEs (e.g., UE 912C and/or 912D), and between the hub 914 and the core network 906. In other examples, the hub 914 is connected to the core network 906 and/or one or more UEs via a wired connection. Moreover, the hub 914 may be configured to connect to a Machine-to-Machine (M2M) service provider over the access network 904 and/or to another UE over a direct connection. In some scenarios, UEs may establish a wireless connection with the network nodes 910 while still connected via the hub 914 via a wired or wireless connection. In some embodiments, the hub 914 may be a dedicated hub—that is, a hub whose primary function is to route communications to/from the UEs from/to the network node 910B. In other embodiments, the hub 914 may be a non-dedicated hub—that is, a device which is capable of operating to route communications between the UEs and the network node 910B, but which is additionally capable of operating as a communication start and/or end point for certain data channels.

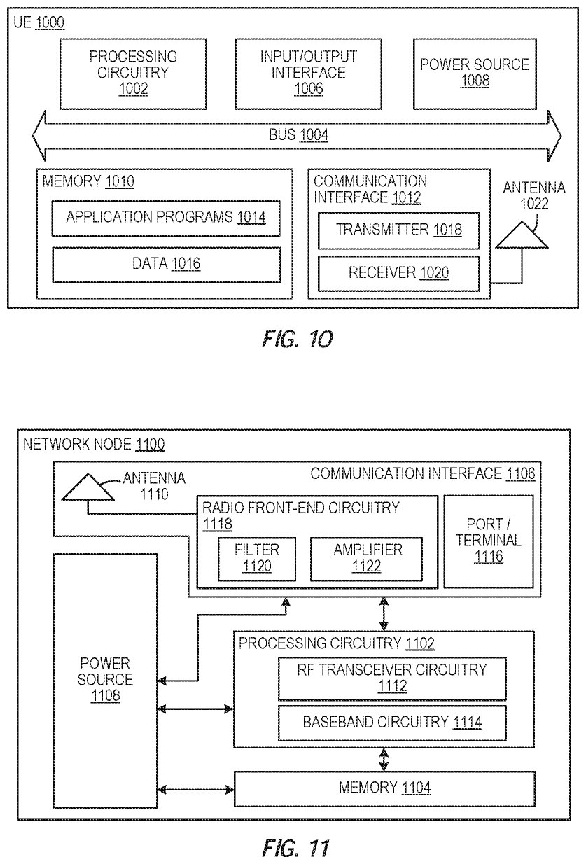

FIG. 10 shows a UE 1000 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VOIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1000 includes processing circuitry 1002 that is operatively coupled via a bus 1004 to an input/output interface 1006, a power source 1008, memory 1010, a communication interface 1012, and/or any other component, or any combination thereof. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

The processing circuitry 1002 is configured to process instructions and data and may be configured to implement any sequential state machine operative to execute instructions stored as machine-readable computer programs in the memory 1010. The processing circuitry 1002 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 1002 may include multiple Central Processing Units (CPUs).

In the example, the input/output interface 1006 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1000. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1008 is structured as a battery or battery pack. Other types of power sources, such as an external power source (e.g., an electricity outlet), photovoltaic device, or power cell, may be used. The power source 1008 may further include power circuitry for delivering power from the power source 1008 itself, and/or an external power source, to the various parts of the UE 1000 via input circuitry or an interface such as an electrical power cable. Delivering power may be, for example, for charging the power source 1008. Power circuitry may perform any formatting, converting, or other modification to the power from the power source 1008 to make the power suitable for the respective components of the UE 1000 to which power is supplied.

The memory 1010 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 1010 includes one or more application programs 1014, such as an operating system, web browser application, a widget, gadget engine, or other application, and corresponding data 1016. The memory 1010 may store, for use by the UE 1000, any of a variety of various operating systems or combinations of operating systems.

The memory 1010 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 1010 may allow the UE 1000 to access instructions, application programs, and the like stored on transitory or non-transitory memory media, to off-load data, or to upload data. An article of manufacture, such as one utilizing a communication system, may be tangibly embodied as or in the memory 1010, which may be or comprise a device-readable storage medium.

The processing circuitry 1002 may be configured to communicate with an access network or other network using the communication interface 1012. The communication interface 1012 may comprise one or more communication subsystems and may include or be communicatively coupled to an antenna 1022. The communication interface 1012 may include one or more transceivers used to communicate, such as by communicating with one or more remote transceivers of another device capable of wireless communication (e.g., another UE or a network node in an access network). Each transceiver may include a transmitter 1018 and/or a receiver 1020 appropriate to provide network communications (e.g., optical, electrical, frequency allocations, and so forth). Moreover, the transmitter 1018 and receiver 1020 may be coupled to one or more antennas (e.g., the antenna 1022) and may share circuit components, software, or firmware, or alternatively be implemented separately.

In the illustrated embodiment, communication functions of the communication interface 1012 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 1012, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1000 shown in FIG. 10.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 11 shows a network node 1100 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1100 includes processing circuitry 1102, memory 1104, a communication interface 1106, and a power source 1108. The network node 1100 may be composed of multiple physically separate components (e.g., a Node B component and an RNC component, or a BTS component and a BSC component, etc.), which may each have their own respective components. In certain scenarios in which the network node 1100 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 1100 may be configured to support multiple RATs. In such embodiments, some components may be duplicated (e.g., separate memory 1104 for different RATs) and some components may be reused (e.g., an antenna 1110 may be shared by different RATs). The network node 1100 may also include multiple sets of the various illustrated components for different wireless technologies integrated into network node 1100, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 1100.

The processing circuitry 1102 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 1100 components, such as the memory 1104, to provide network node 1100 functionality.

In some embodiments, the processing circuitry 1102 includes a System on a Chip (SOC). In some embodiments, the processing circuitry 1102 includes one or more of Radio Frequency (RF) transceiver circuitry 1112 and baseband processing circuitry 1114. In some embodiments, the RF transceiver circuitry 1112 and the baseband processing circuitry 1114 may be on separate chips (or sets of chips), boards, or units, such as radio units and digital units. In alternative embodiments, part or all of the RF transceiver circuitry 1112 and the baseband processing circuitry 1114 may be on the same chip or set of chips, boards, or units.

The memory 1104 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 1102. The memory 1104 may store any suitable instructions, data, or information, including a computer program, software, an application including one or more of logic, rules, code, tables, and/or other instructions capable of being executed by the processing circuitry 1102 and utilized by the network node 1100. The memory 1104 may be used to store any calculations made by the processing circuitry 1102 and/or any data received via the communication interface 1106. In some embodiments, the processing circuitry 1102 and the memory 1104 are integrated.

The communication interface 1106 is used in wired or wireless communication of signaling and/or data between a network node, access network, and/or UE. As illustrated, the communication interface 1106 comprises port(s)/terminal(s) 1116 to send and receive data, for example to and from a network over a wired connection. The communication interface 1106 also includes radio front-end circuitry 1118 that may be coupled to, or in certain embodiments a part of, the antenna 1110. The radio front-end circuitry 1118 comprises filters 1120 and amplifiers 1122. The radio front-end circuitry 1118 may be connected to the antenna 1110 and the processing circuitry 1102. The radio front-end circuitry 1118 may be configured to condition signals communicated between the antenna 1110 and the processing circuitry 1102. The radio front-end circuitry 1118 may receive digital data that is to be sent out to other network nodes or UEs via a wireless connection. The radio front-end circuitry 1118 may convert the digital data into a radio signal having the appropriate channel and bandwidth parameters using a combination of the filters 1120 and/or the amplifiers 1122. The radio signal may then be transmitted via the antenna 1110. Similarly, when receiving data, the antenna 1110 may collect radio signals which are then converted into digital data by the radio front-end circuitry 1118. The digital data may be passed to the processing circuitry 1102. In other embodiments, the communication interface 1106 may comprise different components and/or different combinations of components.

In certain alternative embodiments, the network node 1100 does not include separate radio front-end circuitry 1118; instead, the processing circuitry 1102 includes radio front-end circuitry and is connected to the antenna 1110. Similarly, in some embodiments, all or some of the RF transceiver circuitry 1112 is part of the communication interface 1106. In still other embodiments, the communication interface 1106 includes the one or more ports or terminals 1116, the radio front-end circuitry 1118, and the RF transceiver circuitry 1112 as part of a radio unit (not shown), and the communication interface 1106 communicates with the baseband processing circuitry 1114, which is part of a digital unit (not shown).

The antenna 1110 may include one or more antennas, or antenna arrays, configured to send and/or receive wireless signals. The antenna 1110 may be coupled to the radio front-end circuitry 1118 and may be any type of antenna capable of transmitting and receiving data and/or signals wirelessly. In certain embodiments, the antenna 1110 is separate from the network node 1100 and connectable to the network node 1100 through an interface or port.

The antenna 1110, the communication interface 1106, and/or the processing circuitry 1102 may be configured to perform any receiving operations and/or certain obtaining operations described herein as being performed by the network node 1100. Any information, data, and/or signals may be received from a UE, another network node, and/or any other network equipment. Similarly, the antenna 1110, the communication interface 1106, and/or the processing circuitry 1102 may be configured to perform any transmitting operations described herein as being performed by the network node 1100. Any information, data, and/or signals may be transmitted to a UE, another network node, and/or any other network equipment.

The power source 1108 provides power to the various components of the network node 1100 in a form suitable for the respective components (e.g., at a voltage and current level needed for each respective component). The power source 1108 may further comprise, or be coupled to, power management circuitry to supply the components of the network node 1100 with power for performing the functionality described herein. For example, the network node 1100 may be connectable to an external power source (e.g., the power grid or an electricity outlet) via input circuitry or an interface such as an electrical cable, whereby the external power source supplies power to power circuitry of the power source 1108. As a further example, the power source 1108 may comprise a source of power in the form of a battery or battery pack which is connected to, or integrated in, power circuitry. The battery may provide backup power should the external power source fail.

Embodiments of the network node 1100 may include additional components beyond those shown in FIG. 11 for providing certain aspects of the network node's functionality, including any of the functionality described herein and/or any functionality necessary to support the subject matter described herein. For example, the network node 1100 may include user interface equipment to allow input of information into the network node 1100 and to allow output of information from the network node 1100. This may allow a user to perform diagnostic, maintenance, repair, and other administrative functions for the network node 1100.

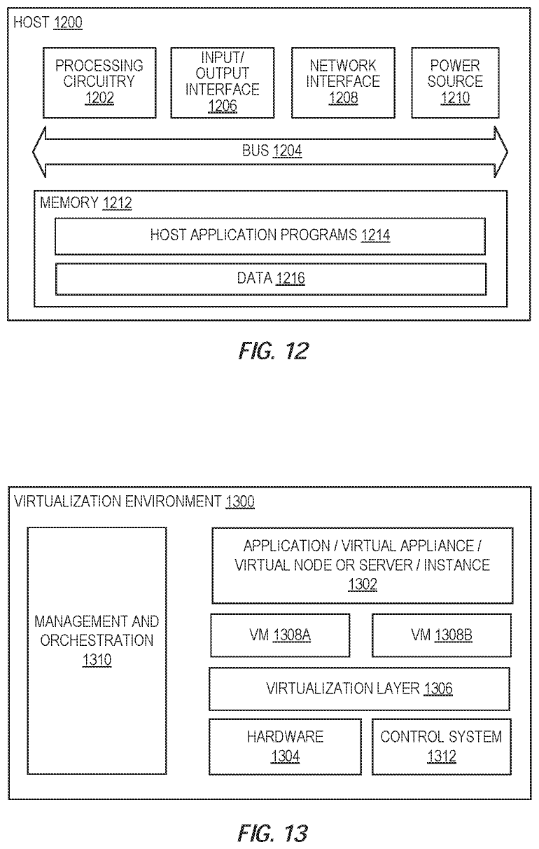

FIG. 12 is a block diagram of a host 1200, which may be an embodiment of the host 916 of FIG. 9, in accordance with various aspects described herein. As used herein, the host 1200 may be or comprise various combinations of hardware and/or software including a standalone server, a blade server, a cloud-implemented server, a distributed server, a virtual machine, container, or processing resources in a server farm. The host 1200 may provide one or more services to one or more UEs.

The host 1200 includes processing circuitry 1202 that is operatively coupled via a bus 1204 to an input/output interface 1206, a network interface 1208, a power source 1210, and memory 1212. Other components may be included in other embodiments. Features of these components may be substantially similar to those described with respect to the devices of previous figures, such as FIGS. 10 and 11, such that the descriptions thereof are generally applicable to the corresponding components of the host 1200.

The memory 1212 may include one or more computer programs including one or more host application programs 1214 and data 1216, which may include user data, e.g. data generated by a UE for the host 1200 or data generated by the host 1200 for a UE. Embodiments of the host 1200 may utilize only a subset or all of the components shown. The host application programs 1214 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 1214 may also provide for user authentication and licensing checks and may periodically report health, routes, and content availability to a central node, such as a device in or on the edge of a core network. Accordingly, the host 1200 may select and/or indicate a different host for Over-The-Top (OTT) services for a UE. The host application programs 1214 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 13 is a block diagram illustrating a virtualization environment 1300 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 1300 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1302 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1304 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1306 (also referred to as hypervisors or VM Monitors (VMMs)), provide VMs 1308A and 1308B (one or more of which may be generally referred to as VMs 1308), and/or perform any of the functions, features, and/or benefits described in relation with some embodiments described herein. The virtualization layer 1306 may present a virtual operating platform that appears like networking hardware to the VMs 1308.

The VMs 1308 comprise virtual processing, virtual memory, virtual networking, or interface and virtual storage, and may be run by a corresponding virtualization layer 1306. Different embodiments of the instance of a virtual appliance 1302 may be implemented on one or more of the VMs 1308, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 1308 may be a software implementation of a physical machine that runs programs as if they were executing on a physical, non-virtualized machine. Each of the VMs 1308, and that part of the hardware 1304 that executes that VM, be it hardware dedicated to that VM and/or hardware shared by that VM with others of the VMs 1308, forms separate virtual network elements. Still in the context of NFV, a virtual network function is responsible for handling specific network functions that run in one or more VMs 1308 on top of the hardware 1304 and corresponds to the application 1302.

The hardware 1304 may be implemented in a standalone network node with generic or specific components. The hardware 1304 may implement some functions via virtualization. Alternatively, the hardware 1304 may be part of a larger cluster of hardware (e.g., such as in a data center or CPE) where many hardware nodes work together and are managed via management and orchestration 1310, which, among others, oversees lifecycle management of the applications 1302. In some embodiments, the hardware 1304 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 1312 which may alternatively be used for communication between hardware nodes and radio units.

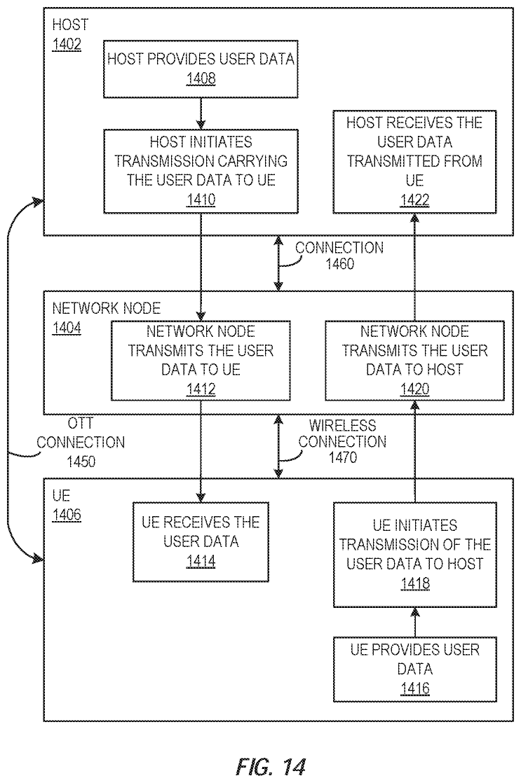

FIG. 14 shows a communication diagram of a host 1402 communicating via a network node 1404 with a UE 1406 over a partially wireless connection in accordance with some embodiments. Example implementations, in accordance with various embodiments, of the UE (such as the UE 912A of FIG. 9 and/or the UE 1000 of FIG. 10), the network node (such as the network node 910A of FIG. 9 and/or the network node 1100 of FIG. 11), and the host (such as the host 916 of FIG. 9 and/or the host 1200 of FIG. 12) discussed in the preceding paragraphs will now be described with reference to FIG. 14.

Like the host 1200, embodiments of the host 1402 include hardware, such as a communication interface, processing circuitry, and memory. The host 1402 also includes software, which is stored in or is accessible by the host 1402 and executable by the processing circuitry. The software includes a host application that may be operable to provide a service to a remote user, such as the UE 1406 connecting via an OTT connection 1450 extending between the UE 1406 and the host 1402. In providing the service to the remote user, a host application may provide user data which is transmitted using the OTT connection 1450.

The network node 1404 includes hardware enabling it to communicate with the host 1402 and the UE 1406 via a connection 1460. The connection 1460 may be direct or pass through a core network (like the core network 906 of FIG. 9) and/or one or more other intermediate networks, such as one or more public, private, or hosted networks. For example, an intermediate network may be a backbone network or the Internet.

The UE 1406 includes hardware and software, which is stored in or accessible by the UE 1406 and executable by the UE's processing circuitry. The software includes a client application, such as a web browser or operator-specific “app” that may be operable to provide a service to a human or non-human user via the UE 1406 with the support of the host 1402. In the host 1402, an executing host application may communicate with the executing client application via the OTT connection 1450 terminating at the UE 1406 and the host 1402. In providing the service to the user, the UE's client application may receive request data from the host's host application and provide user data in response to the request data. The OTT connection 1450 may transfer both the request data and the user data. The UE's client application may interact with the user to generate the user data that it provides to the host application through the OTT connection 1450.

The OTT connection 1450 may extend via the connection 1460 between the host 1402 and the network node 1404 and via a wireless connection 1470 between the network node 1404 and the UE 1406 to provide the connection between the host 1402 and the UE 1406. The connection 1460 and the wireless connection 1470, over which the OTT connection 1450 may be provided, have been drawn abstractly to illustrate the communication between the host 1402 and the UE 1406 via the network node 1404, without explicit reference to any intermediary devices and the precise routing of messages via these devices.

As an example of transmitting data via the OTT connection 1450, in step 1408, the host 1402 provides user data, which may be performed by executing a host application. In some embodiments, the user data is associated with a particular human user interacting with the UE 1406. In other embodiments, the user data is associated with a UE 1406 that shares data with the host 1402 without explicit human interaction. In step 1410, the host 1402 initiates a transmission carrying the user data towards the UE 1406. The host 1402 may initiate the transmission responsive to a request transmitted by the UE 1406. The request may be caused by human interaction with the UE 1406 or by operation of the client application executing on the UE 1406. The transmission may pass via the network node 1404 in accordance with the teachings of the embodiments described throughout this disclosure. Accordingly, in step 1412, the network node 1404 transmits to the UE 1406 the user data that was carried in the transmission that the host 1402 initiated, in accordance with the teachings of the embodiments described throughout this disclosure. In step 1414, the UE 1406 receives the user data carried in the transmission, which may be performed by a client application executed on the UE 1406 associated with the host application executed by the host 1402.

In some examples, the UE 1406 executes a client application which provides user data to the host 1402. The user data may be provided in reaction or response to the data received from the host 1402. Accordingly, in step 1416, the UE 1406 may provide user data, which may be performed by executing the client application. In providing the user data, the client application may further consider user input received from the user via an input/output interface of the UE 1406. Regardless of the specific manner in which the user data was provided, the UE 1406 initiates, in step 1418, transmission of the user data towards the host 1402 via the network node 1404. In step 1420, in accordance with the teachings of the embodiments described throughout this disclosure, the network node 1404 receives user data from the UE 1406 and initiates transmission of the received user data towards the host 1402. In step 1422, the host 1402 receives the user data carried in the transmission initiated by the UE 1406.

One or more of the various embodiments improve the performance of OTT services provided to the UE 1406 using the OTT connection 1450, in which the wireless connection 1470 forms the last segment. More precisely, the teachings of these embodiments may improve the e.g., data rate, latency, power consumption, etc. and thereby provide benefits such as e.g., reduced user waiting time, relaxed restriction on file size, improved content resolution, better responsiveness, extended battery lifetime, etc.

In an example scenario, factory status information may be collected and analyzed by the host 1402. As another example, the host 1402 may process audio and video data which may have been retrieved from a UE for use in creating maps. As another example, the host 1402 may collect and analyze real-time data to assist in controlling vehicle congestion (e.g., controlling traffic lights). As another example, the host 1402 may store surveillance video uploaded by a UE. As another example, the host 1402 may store or control access to media content such as video, audio, VR, or AR which it can broadcast, multicast, or unicast to UEs. As other examples, the host 1402 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 1450 between the host 1402 and the UE 1406 in response to variations in the measurement results. The measurement procedure and/or the network functionality for reconfiguring the OTT connection 1450 may be implemented in software and hardware of the host 1402 and/or the UE 1406. In some embodiments, sensors (not shown) may be deployed in or in association with other devices through which the OTT connection 1450 passes; the sensors may participate in the measurement procedure by supplying values of the monitored quantities exemplified above, or by supplying values of other physical quantities from which software may compute or estimate the monitored quantities. The reconfiguring of the OTT connection 1450 may include message format, retransmission settings, preferred routing, etc.; the reconfiguring need not directly alter the operation of the network node 1404. Such procedures and functionalities may be known and practiced in the art. In certain embodiments, measurements may involve proprietary UE signaling that facilitates measurements of throughput, propagation times, latency, and the like by the host 1402. The measurements may be implemented in that software causes messages to be transmitted, in particular empty or ‘dummy’ messages, using the OTT connection 1450 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

### EMBODIMENTS

### Group A Embodiments

Embodiment 1: A method performed by a user equipment for associating Uplink, UL, channels and/or signals to a Timing Advance Group, TAG, the method comprising one or more of: grouping UL channels and/or signals into at least two groups, each associated with a TAG; associating a TAG index with an UL channel and/or signal; including a TAG ID in a spatial relation Information Element, IE; including a TAG ID in a pathloss reference signal configuration; including a TAG ID in a unified Transmission Configuration Indication, TCI, state; and associating a TAG ID to a set of Synchronization Signal Blocks, SSBs, and/or a Channel State Information-Reference Signal, CSI-RS.

Embodiment 2: The method of the previous embodiment wherein associating a TAG index comprises one or more of the group consisting of: each channel/signal configured with a spatial relation uses the associated TAG; each channel/signal configured with a pathloss RS uses the associated TAG; each UL signal associated with an SSB or a Non-Zero Power, NZP, CSI-RS resource uses the associated TAG; each UL channel/signal configured with an UL TCI state uses the associated TAG.

Embodiment 3: The method of any of the previous embodiments wherein a TAG ID is explicitly configured in the corresponding spatial relation information element (e.g., SRS-SpatialRelationInfo, PUCCH-SpatialRelationInfo, etc.).

Embodiment 4: The method of any of the previous embodiments a first TAG is provided by the ‘tag-Id’ configured in the ServingCellConfig of the serving cell.

Embodiment 5: The method of any of the previous embodiments a second TAG is configured in SRS-SpatialRelationInfo and/or PUCCH-SpatialRelationInfo if the associated SRS/PUSCH or PUCCH are to be transmitted to a TRP associated with a second TAG.

Embodiment 6: The method of any of the previous embodiments, when ‘tag-Id’ is not configured in SRS-SpatialRelationInfo of an SRS spatial relation, then the first ‘tag-Id’ configured in the ServingCellConfig applies to that SRS spatial relation.

Embodiment 7: The method of any of the previous embodiments, when ‘tag-Id’ is not configured in PUCCH-SpatialRelationInfo of an PUCCH spatial relation, then the first ‘tag-Id’ configured in the ServingCellConfig applies to that PUCCH spatial relation.

Embodiment 8: The method of any of the previous embodiments the association with TAG is explicitly configured in the corresponding pathloss RS for each UL channel or signal (e.g., PUCCH-PathlossReferenceRS, PUSCH-PathlossReferenceRS, PathlossReferenceRS-r16).

Embodiment 9: The method of any of the previous embodiments the association with TAG is explicitly configured for each SSB and CSI-RS used for pathloss reference RS (e.g., NZP-CSI-RS-Resource).

Embodiment 10: The method of any of the previous embodiments, for SSB to TAG association, a set of SSB indices may be added to each TAG (e.g., TAG-Config).

Embodiment 11: The method of any of the previous embodiments each joint DL/UL or UL TCI state may include a TAG-Id (e.g., DLorJoint-TCIState-r18, UL-TCIState-r18, etc.).

Embodiment 12: The method of any of the previous embodiments the ‘tag-Id’ is optionally configured in DLorJoint-TCIState and/or UL-TCIState.

Embodiment 13: The method of any of the previous embodiments the first TAG is provided by the ‘tag-Id’ configured in the ServingCellConfig of the serving cell in which SRS, PUCCH, or PUSCH is transmitted.

Embodiment 14: The method of any of the previous embodiments, further comprising: providing user data; and forwarding the user data to a host via the transmission to the network node.

### Group B Embodiments

Embodiment 15: A method performed by a network node for associating Uplink, UL, channels and/or signals to a Timing Advance Group, TAG, the method comprising one or more of: grouping UL channels and/or signals into at least two groups, each associated with a TAG; associating a TAG index with an UL channel and/or signal; including a TAG ID in a spatial relation Information Element, IE; including a TAG ID in a pathloss reference signal configuration; including a TAG ID in a unified Transmission Configuration Indication, TCI, state; and associating a TAG ID to a set of Synchronization Signal Blocks, SSBs, and/or a Channel State Information-Reference Signal, CSI-RS.

Embodiment 16: The method of the previous embodiment wherein associating a TAG index comprises one or more of the group consisting of: each channel/signal configured with a spatial relation uses the associated TAG; each channel/signal configured with a pathloss RS uses the associated TAG; each UL signal associated with an SSB or a Non-Zero Power, NZP, CSI-RS resource uses the associated TAG; each UL channel/signal configured with an UL TCI state uses the associated TAG.

Embodiment 17: The method of any of the previous embodiments wherein a TAG ID is explicitly configured in the corresponding spatial relation information element (e.g., SRS-SpatialRelationInfo, PUCCH-SpatialRelationInfo, etc.).

Embodiment 18: The method of any of the previous embodiments a first TAG is provided by the ‘tag-Id’ configured in the ServingCellConfig of the serving cell.

Embodiment 19: The method of any of the previous embodiments a second TAG is configured in SRS-SpatialRelationInfo and/or PUCCH-SpatialRelationInfo if the associated SRS/PUSCH or PUCCH are to be transmitted to a TRP associated with a second TAG.

Embodiment 20: The method of any of the previous embodiments, when ‘tag-Id’ is not configured in SRS-SpatialRelationInfo of an SRS spatial relation, then the first ‘tag-Id’ configured in the ServingCellConfig applies to that SRS spatial relation.

Embodiment 21: The method of any of the previous embodiments, when ‘tag-Id’ is not configured in PUCCH-SpatialRelationInfo of an PUCCH spatial relation, then the first ‘tag-Id’ configured in the ServingCellConfig applies to that PUCCH spatial relation.

Embodiment 22: The method of any of the previous embodiments the association with TAG is explicitly configured in the corresponding pathloss RS for each UL channel or signal (e.g., PUCCH-PathlossReferenceRS, PUSCH-PathlossReferenceRS, PathlossReferenceRS-r16).

Embodiment 23: The method of any of the previous embodiments the association with TAG is explicitly configured for each SSB and CSI-RS used for pathloss reference RS (e.g., NZP-CSI-RS-Resource).

Embodiment 24: The method of any of the previous embodiments, for SSB to TAG association, a set of SSB indices may be added to each TAG (e.g., TAG-Config).

Embodiment 25: The method of any of the previous embodiments each joint DL/UL or UL TCI state may include a TAG-Id (e.g., DLorJoint-TCIState-r18, UL-TCIState-r18, etc.).

Embodiment 26: The method of any of the previous embodiments the ‘tag-Id’ is optionally configured in DLorJoint-TCIState and/or UL-TCIState.

Embodiment 27: The method of any of the previous embodiments the first TAG is provided by the ‘tag-Id’ configured in the ServingCellConfig of the serving cell in which SRS, PUCCH, or PUSCH is transmitted.

Embodiment 28: The method of any of the previous embodiments, further comprising: obtaining user data; and forwarding the user data to a host or a user equipment.

### Group C Embodiments

Embodiment 29: A user equipment for associating Uplink, UL, channels and/or signals to a Timing Advance Group, TAG, comprising: processing circuitry configured to perform any of the steps of any of the Group A embodiments; and power supply circuitry configured to supply power to the processing circuitry.

Embodiment 30: A network node for associating Uplink, UL, channels and/or signals to a Timing Advance Group, TAG, the network node comprising: processing circuitry configured to perform any of the steps of any of the Group B embodiments; power supply circuitry configured to supply power to the processing circuitry.

Embodiment 31: A user equipment (UE) for associating Uplink, UL, channels and/or signals to a Timing Advance Group, TAG, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 32: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to receive the user data from the host.

Embodiment 33: The host of the previous embodiment, wherein the cellular network further includes a network node configured to communicate with the UE to transmit the user data to the UE from the host.

Embodiment 34: The host of the previous 2 embodiments, wherein: the processing circuitry of the host is configured to execute a host application, thereby providing the user data; and the host application is configured to interact with a client application executing on the UE, the client application being associated with the host application.

Embodiment 35: A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Embodiment 36: The method of the previous embodiment, further comprising: at the host, executing a host application associated with a client application executing on the UE to receive the user data from the UE.

Embodiment 37: The method of the previous embodiment, further comprising: at the host, transmitting input data to the client application executing on the UE, the input data being provided by executing the host application, wherein the user data is provided by the client application in response to the input data from the host application.

Embodiment 38: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to transmit the user data to the host.

Embodiment 39: The host of the previous embodiment, wherein the cellular network further includes a network node configured to communicate with the UE to transmit the user data from the UE to the host.

Embodiment 40: The host of the previous 2 embodiments, wherein: the processing circuitry of the host is configured to execute a host application, thereby providing the user data; and the host application is configured to interact with a client application executing on the UE, the client application being associated with the host application.

Embodiment 41: A method implemented by a host configured to operate in a communication system that further includes a network node and a user equipment (UE), the method comprising: at the host, receiving user data transmitted to the host via the network node by the UE, wherein the UE performs any of the steps of any of the Group A embodiments to transmit the user data to the host.

Embodiment 42: The method of the previous embodiment, further comprising: at the host, executing a host application associated with a client application executing on the UE to receive the user data from the UE.

Embodiment 43: The method of the previous embodiment, further comprising: at the host, transmitting input data to the client application executing on the UE, the input data being provided by executing the host application, wherein the user data is provided by the client application in response to the input data from the host application.

Embodiment 44: A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

Embodiment 45: The host of the previous embodiment, wherein: the processing circuitry of the host is configured to execute a host application that provides the user data; and the UE comprises processing circuitry configured to execute a client application associated with the host application to receive the transmission of user data from the host.

Embodiment 46: A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B embodiments to transmit the user data from the host to the UE.

Embodiment 47: The method of the previous embodiment, further comprising, at the network node, transmitting the user data provided by the host for the UE.

Embodiment 48: The method of any of the previous 2 embodiments, wherein the user data is provided at the host by executing a host application that interacts with a client application executing on the UE, the client application being associated with the host application.

Embodiment 49: A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

Embodiment 50: The communication system of the previous embodiment, further comprising: the network node; and/or the user equipment.

Embodiment 51: A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

Embodiment 52: The host of the previous 2 embodiments, wherein: the processing circuitry of the host is configured to execute a host application, thereby providing the user data; and the host application is configured to interact with a client application executing on the UE, the client application being associated with the host application.

Embodiment 53: The host of the any of the previous 2 embodiments, wherein the initiating receipt of the user data comprises requesting the user data.

Embodiment 54: A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B embodiments to receive the user data from the UE for the host.

Embodiment 55: The method of the previous embodiment, further comprising at the network node, transmitting the received user data to the host.

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation.
5GC Fifth Generation Core.
5GS Fifth Generation System
AF Application Function
AMF Access and Mobility Function.
AN Access Network
AP Access Point
ASIC Application Specific Integrated Circuit
AUSF Authentication Server Function
CORESET Control Resource Set
CPU Central Processing Unit
CSI-RS Channel State Information Reference Signal
DL Downlink
DN Data Network.
DSP Digital Signal Processor
eNB Enhanced or Evolved Node B
EPS Evolved Packet System
E-UTRA Evolved Universal Terrestrial Radio Access
FPGA Field Programmable Gate Array
gNB New Radio Base Station
gNB-DU New Radio Base Station Distributed Unit
HSS Home Subscriber Server
IoT Internet of Things
IP Internet Protocol
LTE Long Term Evolution
MIB Master Information Block.
MME Mobility Management Entity
MTC Machine Type Communication
NEF Network Exposure Function
NF Network Function
NR New Radio
NRF Network Function Repository Function
NSSF Network Slice Selection Function
NZP Non-Zero Power
OTT Over-the-Top
PC Personal Computer
PCF Policy Control Function
P-GW Packet Data Network Gateway
PUCCH Physical Uplink Control Channel
PUSCH Physical Uplink Shared Channel
QoS Quality of Service
RACH Random Access Channel
RAM Random Access Memory
RAN Radio Access Network
ROM Read Only Memory
RRH Remote Radio Head
RS Reference Signal
RTT Round Trip Time
SCEF Service Capability Exposure Function
SIB Secondary Information Block
SMF Session Management Function
SRS Sounding Reference Signal
SSB Synchronization Signal Block
TAG Timing Advance Group
TCI Transmission Configuration Indication
TRP Transmission Reception Point
UDM Unified Data Management
UE User Equipment
UL Uplink
UPF User Plane Function

Those skilled in the art will recognize improvements and modifications to the embodiments of the present disclosure. All such improvements and modifications are considered within the scope of the concepts disclosed herein.

1. A method performed by a User Equipment, UE, for associating Uplink, UL, channels and/or signals to a Timing Advance Group, TAG, the method comprising:
grouping UL channels and/or signals into at least two groups, each associated with a TAG;
associating a TAG index with a UL channel and/or signal by one or more of:
configuring an identifier representing the TAG in a UL Transmission Configuration Indication, TCI, state; and
configuring an identifier representing the TAG in a joint TCI state; and
utilizing, for UL transmission, the timing advance of the identifier representing the TAG associated with the UL channel and/or signal.

2-35. (canceled)
